(19) United States
(12) Patent Application Publication
(10) Pub. No.: US 2005/0214423 A1
(43) Pub. Date: Sep. 29, 2005

(54) Non allergenic egg substitute

(76) Inventors: Zeesha Stock, Morsey, NY (US); Dinah Stock, Morsey, NY (US)

Correspondence Address: Thomas A. O'Rourke;Bodner & O'Rourke, 425 Broadhollow Road, Melville, NY, 11747, US

(21) Appl. No.: 10/810,320

(22) Filed: Mar. 27, 2004

(51) Int. Cl. A23B 4/00

(52) U.S. Cl. 426/531

(57) ABSTRACT

An egg substitute composition for use by persons allergic to eggs is disclosed. The composition includes, water, vegetable oil and a gum.

### FIELD OF THE INVENTION

The present invention is directed to improved compositions that may be used as a substitute for egg in many recipes particularly in recipes for persons who suffer from allergies from eggs and egg based products.

### BACKGROUND OF THE INVENTION

One of the more common causes of food allergy in infants and young children is the egg. Although according to some studies, many children outgrow the allergy by the age of five not every child is so fortunate. There are many instances where even adults are allergic to egg. It has been estimated that egg allergy is present in nearly two-thirds of children with atopic dermatitis (Sampson, H. A. J. 1997 Roy. Soc. Med. 90(suppl 30):3-9). When egg allergic children are placed on a diet devoid of all egg protein, about one-third develop clinical tolerance to egg within 2 years, even though IgE antibodies to egg (e.g. positive prick skin tests) persist for several years (Sampson 1989). Ovomucoid (Gal d 1) is the dominant allergen in hen's egg, and children with persistent egg allergy have significantly higher concentrations of IgE anti-ovomucoid antibodies than those who “outgrow” their reactivity (Bernhisel-Broadbent, J., et al. 1994. J Allergy Clin Immunol 93:1047-1059). Ovomucoid is a glycoprotein comprised of 186 amino acids arranged in three tandem domains containing nine intra-domain disulfide bonds and five carbohydrate side chains (Kato, et al. 1987. Biochemistry 26:193-201).

Food allergies occur when a person's immune system mistakenly believes that something he or she ate is harmful to the body. In an attempt to protect the body, the immune system produces antibodies, called immunoglobulin E (IgE), to that food. Those antibodies then cause mast cells (allergy cells in the body) to release chemicals, one of which is histamine, into the bloodstream. The histamine then acts on a person's eyes, nose, throat, lungs, skin, or gastrointestinal tract and causes the symptoms of the allergic reaction. Future exposure to that same allergen (things like eggs or nuts or pollen that you can be allergic to are known as allergens) will trigger this antibody response again. This means that every time that person eats that particular food, he or she will have an allergic reaction.

People who are allergic to eggs may feel sick just a few minutes after consuming egg proteins or up to a couple of hours later. Most reactions last less than a day and may affect any of three body systems:
1) the skin—in the form of red, itchy, bumpy rashes (hives) or eczema
2) the gastrointestinal tract—in the form of stomach cramps, diarrhea, nausea, or vomiting
3) the respiratory tract—symptoms can range from a runny nose and sneezing to the triggering of asthma with coughing and wheezing

People who have a serious egg allergy may experience anaphylaxis—a severe allergic reaction that causes swelling of the mouth, throat, and airways leading to the lungs, resulting in an inability to breathe. In addition, anaphylaxis causes a dangerous drop in blood pressure, which can make someone dizzy or pass out, and may quickly lead to shock. For people who are especially sensitive to eggs, even egg fumes or getting egg on the skin can cause an anaphylactic reaction, so eggs should be kept out of the home completely.

The egg is made up of various proteins, many of which are highly allergenic. The four major allergenic proteins of hen's egg white are ovomucoid, ovalbumin, ovotransfferin, and lysozyme. Ovalbumin, the major allergen, makes up fifty percent of an egg white. Most people with an egg allergy are allergic to the egg white proteins, but there are those who are allergic to the yolk. The egg yolk contains different allergenic proteins than the egg white. These proteins are typically apovitellenins I, apovitellenins VI, and phosvitin.

Some of those who suffer from an egg yolk allergy usually have the reaction triggered by inhaled bird antigens. This is referred to as Bird-egg syndrome. Sometimes an egg allergy can be seasonal. Those allergic to oak pollen, short and western ragweed, and the goosefoot family of weeds, may cross react with eggs when these pollens are in season.

The symptoms typically associated with egg allergy include allergic rhinitis, asthma, dermatitis, diarrhea, gastrointestinal symptoms, hives, nausea, oral allergy syndrome, vomiting, wheezing, and in some cases, anaphylaxis and others.

The many foods which contain eggs or egg products include many baked goods, baking mixes, batters, bearnaise sauce, boiled frostings, breaded meats, breakfast cereals, cake flours, some candies, cookies, creamy fillings, croquettes, custards, egg nog, egg noodles, most egg substitutes, French toast, fondants, frozen desserts, Hollandaise sauce, some hot dogs, ice cream, macaroons, marshmallow products, macaroni, malted cocoa drinks, mayonnaise, meatloafs, meringues, noodle soups, pancakes, many processed meats, puddings, root beers, many salad dressings, sausages, some sherbet, spaghetti, tartar sauce, waffles, and some wines. Sometimes pretzels, bagels, buns, candy or other baked goods are brushed with egg white to give them a shiny appearance. Cosmetics, shampoos, laxatives, and pharmaceuticals sometimes contain egg proteins.

One of the problems that a person who suffers from an allergic reaction to eggs is that eggs are not always listed as egg white, egg white solids, egg yolk, egg solids, powdered egg, or whole egg on ingredients labels. Frequently, the terms albumin, globulin, livetin, lysozyme, ovalbumin, ovoglobulin, ovomucin, ovomucoid, ovotransferrin, ovovitelia, ovovitellin, silici albuminate, simplesse, and vitellin may be used. Lecithin a very common ingredient in packaged food is also problematical as many times lecithin is made with egg yolks.

Because of the number of instances that egg is used in packaged foods many parents will try to use an egg substitute in a recipe. There are a number of egg substitutes that are available. For example, the eggs in a recipe can be completely eliminated if the recipe only calls for one or two. All that is needed is to add a couple extra tablespoons of liquid to balance the moisture content of the product. Depending on how the eggs are used in a recipe, there are various substitutes that can be used. For example, where the egg is used as a binder mashed banana, apple sauce or pureed prunes can be used. Also available as a substitute is ground flaxseed, a combination of 1½ tablespoons water, 1½ tablespoons oil, and 1 teaspoon baking powder, unflavored gelatin, apricot puree, soft tofu or soy milk.

Where the egg is called for in the recipe as a leavening agent the egg may be replaced by carbonated water and baking flour or baking powder, water, and vinegar. Another substitute for the leavening provided eggs is yeast dissolved in warm water or soy flour and water or bean flour and oil. Another substitute for eggs is arrowroot powder mixed with water, cornstarch mixed with water or gluten flour or unbleached white flour, and corn oil.

An egg substitute made from a non elastic protein material, oil and salt followed by heating at a low temperature is described in U.S. Pat. No. 4,120,986.

### SUMMARY OF THE INVENTION

The present invention is directed to an improved egg substitute that is economical both in the cost of its ingredients as well as the labor required to formulate the composition. The composition of the present invention has no cholesterol, almost no calories and virtually no nutritional value. The composition however, has anti-oxidant properties. The present invention is directed to a substitute for eggs in a variety of recipes where eggs, egg whites and/or egg yolks are called for. The present invention is not limited to recipes where only one or two eggs are called for. In fact, the formulations of the present invention can be used in egg recipes where eggs are a significant ingredient. The composition of the present invention is non-allergenic to persons who suffer from allergies to eggs. The composition of the present invention contains water, a vegetable oil preferably a vegetable oil low in saturated fatty acids and high in monounsaturated fatty acids and moderate in polyunsaturated fatty acids. Preferably the oil has 5 to 10% saturates, 55 to 65% monounsaturates and 30 to 40% polyunsaturated. A preferred oil is canola oil. The third ingredient is a gum. The gum is preferably xanthan gum. Alternatively acetic acid i.e. vinegar, preferably an apple cider vinegar can be added. In order to obtain the best results in most recipes the composition is to be mixed together prior to being added to the recipe in lieu of an egg.

### DETAILED DESCRIPTION OF THE INVENTION

Many recipes in baking and other food products call for the addition of one or more eggs. The present invention is typically not directed to a substitute egg for use in an egg dish such as scrambled eggs, omelettes, etc. The present invention is directed to a substitute for eggs where eggs are part of a recipe calling for a number of different ingredients. The present invention may be used in baked goods, baking mixes, batters, bearnaise sauce, boiled frostings, breaded meats, breakfast cereals, cake flours, some candies, cookies, creamy fillings, croquettes, custards, egg nog, egg noodles, French toast, fondants, frozen desserts, Hollandaise sauce, some hot dogs, ice cream, macaroons, macaroni, malted cocoa drinks, mayonnaise, meatloafs, pancakes, many processed meats, puddings, many salad dressings, sausages, some sherbet, spaghetti, tartar sauce, waffles etc. Other products can include pretzels, bagels, buns, candy or other baked goods are brushed with egg white to give them a shiny appearance. The composition may also be used in cosmetics, shampoos, laxatives, and pharmaceuticals.

The composition of the egg substitute of the present invention includes water, an edible oil such as a vegetable oil preferably a vegetable oil low in saturated fatty acids and high in monounsaturated fatty acids and moderate in polyunsaturated fatty acids. Preferably the oil has 5 to 10% saturates, 55 to 65% monounsaturates and 30 to 40% polyunsaturated. A preferred oil is canola oil. One type of oil that may be used is a vitamin E containing oil. Also beta carotene can be added for coloring. The third ingredient is a gum. The gum is preferably xanthan gum. Xanthan gum is a microbial dessication-resistant polymer prepared commercially by aerobic submerged fermentation from Xanthomonas campestris. It is naturally produced by these bacteria to stick the bacteria to the leaves of cabbage-like plants. The material is commercially harvested from the bacteria.

Xanthan gum is a long chain polysacharide composed of the sugars glucose, mannose, and glucuronic acid. The backbone is similar to cellulose, with added sidechains of trisacharides (three sugars in a chain). Xanthan has a particularly complicated molecular structure. however the backbone of xanthan is a β 1-4-D-glucose which is the same as cellulose. Every alternate glucose reside has a three sugar side chain consisting of two mannose residues with a glucuronic acid residue between them. The mannose reside nearest the main chain can carry a C6 acetyl group and the terminal mannose can carry a pyruvate group between C4 and C6. The acetylation and pyruvylation levels vary depending on fermentation conditions but typical values. Typically pyruvate residues can be found on 30-40% of the terminal mannose residues whereas 60-70% of the internal mannose residues may contain acetate groups.

The composition is preferably made in the following proportions: about 11 to about 30 ounces of water to 1 ounce of an oil such as canola oil to ¾ teaspoon of xanthan gum. A more preferable composition of the egg substitute of the present invention may have the composition of about 13 to about 20 ounces of water to 1 ounce of an oil such as canola oil. The xanthan gum may be present in an amount of about ¾ teaspoon of xanthan gum. In a most preferred embodiment the composition may be 14 to 18 ounces of water to about 1 ounce of an oil such as canola oil, and about ¾ teaspoon of xanthan gum. About 2 ounces of these compositions are used as a substitute for a single average sized egg.

Other gums that may be used instead of xanthan gum include locust bean gum, guar gum, gum ghate, tragacanth gum, carrageenan and gellan gum. The oil may include such other oils as soybean oil, corn oil, cottonseed oil, sunflower oil, palm oil, fish oil, safflower oil, olive oil and coconut oil.

### EXAMPLE

A composition was prepared having 15 ounces of water, 1 ounce of canola oil and ¾ teaspoon of xanthan gum. The composition was mixed and two ounces were added to a recipe calling for a single egg.

In an alternative embodiment, the composition may include about 1 to about 2 ounces of acetic acid (vinegar) preferably an apple cider vinegar or other acidifying agent. Typical acidifying agents include Citric Acid, Anhydrous Citric Acid, Monohydrate DL-Lactic Acid, DL-Malic Acid, DL-Tartaric Acid, Fumaric Acid, L-Malic Acid, L-Tartaric Acid, Potassium Acid Tartrate, Potassium Citrate, Potassium DL-Bitartarate, Potassium Gluconate, Sodium Lactate, Sodium L-Tartrate and Sodium Citrate.

It is usually very important in the present invention to premix the egg substitute of the present invention prior to adding it to any recipe. If the ingredients are added without premixing, there is a greater risk that the composition will not work as well in the recipe. The eggs in many recipes hold the composition together as well as providing moisture for the recipe. In baked goods, the egg substitute gives the baked goods the same type of texture as baked goods made with eggs. Thus, pancakes and waffles have the “spongy”, “bendy” texture of egg containing waffles and pancakes.

The composition of the present invention has been found to be particularly useful in recipes for making baked goods such as puff pastries, yeast doughs, soft blend cookies, pancakes, waffles, cookies, including pressed cookies, blintzes and the like.

The addition of apple cider is believed to prolong shelf life and reacts with baking soda in cake mixes to create carbon dioxide bubbles which will get trapped in the mix causing it to rise as well as solidify the cake with the xanthan gum.

The composition of the present invention may also be used as an eggless mayonnaise. Instead of the eggs the gum, oil and water mixture can be mixed together along with 1 to 2 ounces of apple pectin and any desired spices. The composition is preferably mixed in a blender to thoroughly mix the ingredients.

If the egg substitute is desired to be used in food products that need to be boiled such as kneidelach, dumplings and others, it is preferred that arrow root starch or other starch be added to the composition.

1. An egg substitute composition for use by persons allergic to eggs, comprising about 2 ounces per egg of a mixture comprising a ratio of about 11 to 30 ounces of water, to about 1 ounce of a vegetable oil, to about ¾ teaspoon of a gum.

2. An egg substitute composition for use by persons allergic to eggs, comprising about 2 ounces per egg of a mixture comprising a ratio of about 11 to 20 ounces of water, to about 1 ounce of a vegetable oil, to about ¾ teaspoon of a gum.

3. An egg substitute composition for use by persons allergic to eggs, comprising about 2 ounces per egg of a mixture comprising a ratio of about 14 to 18 ounces of water, to about 1 ounce of a vegetable oil, to about ¾ teaspoon of a gum.

4. The composition according to claim 3 wherein the oil is selected from the group consisting of soybean oil, corn oil, cottonseed oil, flax seed oil, safflower oil, sunflower oil, palm oil, coconut oil, canola oil, olive oil and fish oil.

5. The composition according to claim 3 wherein the gum is selected from the group consisting of xanthan gum, locust bean gum, guar gum, gum ghate, tragacanth gum, carrageenan gum and gellan gum.

6. The composition according to claim 4 wherein the gum is selected from the group consisting of xanthan gum, locust bean gum, guar gum, gum ghate, tragacanth gum, carrageenan gum and gellan gum.

7. The composition according to claim 3 wherein there is a ratio of about 15 ounces of water, to 1 ounce of canola oil and ¾ teaspoon of xanthan gum.

8. The composition according to claim 3 wherein the gum is xanthan gum and the oil is canola oil.

9. The composition according to claim 7 wherein vinegar is substituted for a portion of the water.

10. The composition of claim 3 used as a substitute for one or more eggs in a product containing flour.

11. A method of making an egg substitute comprising mixing together about 1.5 to about 2 ounces of water, about 1 teaspoon of a vegetable oil, and about ⅛ to about ½ teaspoons of a gum and adding the composition to a recipe which requires the use of an egg.

12. The composition according to claim 3 further comprising an acidifying agent.

13. The composition of claim 3 used as a substitute for one or more eggs in a product containing a starch.
